(19) United States
(12) Patent Application Publication
(10) Pub. No.: US 2015/0061310 A1
(43) Pub. Date: Mar. 5, 2015

(54) SUCTION DEVICE

(71) Applicant: HON HAI PRECISION INDUSTRY CO., LTD., New Taipei (TW)

(72) Inventor: CHEN-YU YU, New Taipei (TW)

(21) Appl. No.: 14/469,570

(22) Filed: Aug. 26, 2014

(30) Foreign Application Priority Data
Aug. 27, 2013 (TW) 102130637

(51) Int. Cl. B25J 15/06

(52) U.S. Cl. CPC B25J 15/0616
USPC 294/185

(57) ABSTRACT

A suction device to lift workpieces includes a sucking plate, a vacuum suction pipe, and a number of guide boards. The sucking plate includes a bottom wall, a top wall, and a number of side walls. A ventilated cavity is surrounded by the bottom wall, the top wall, and the side walls. A number of uniformly-distributed sucking holes are defined in the bottom wall, in communication with the ventilated cavity. A connecting hole is defined in the top wall and is in communication with the ventilated cavity. The vacuum suction pipe draws air from the ventilated cavity. The guide boards are connected to the edges of the bottom wall and create spaces to maneuver the workspace into correct alignment as it approaches the bottom wall. The two guide boards open out from the top wall.

### FIELD

The subject matter herein generally relates to handling devices.

### BACKGROUND

In optics communications, manufacturing an optics communications module usually use a suction device to vacuum-lift an optical coupling lens, and place the optical coupling lens assembly in a circuit board. But the process is unstable and has low accuracy for manufacturing an optics communications module.

### BRIEF DESCRIPTION OF THE DRAWINGS

Implementations of the present technology will now be described, by way of example only, with reference to the attached figures.

FIG. 1 is an isometric view of a suction device and a workpiece, according to one embodiment.

FIG. 2 is cross section view of a suction device along line—in FIG. 1.

FIG. 3 is a plan view of a bottom wall of a suction device of FIG. 1.

FIG. 4 is an exploded, isometric view of a suction device of FIG. 1 vacuum-lifting a workpiece.

FIG. 5 is a plan view of a bottom wall of a suction device, according to one embodiment.

FIG. 6 is a plan view of a bottom wall of a suction device, according to one embodiment.

FIG. 7 is a plan view of a bottom wall of a suction device, according to one embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

A definition that applies throughout this disclosure will now be presented.

The term “comprising, ” when utilized, means “including, but not necessarily limited to”; it specifically indicates open-ended inclusion or membership in the so-described combination, group, series and the like.

The present disclosure is described in relation to a suction device.

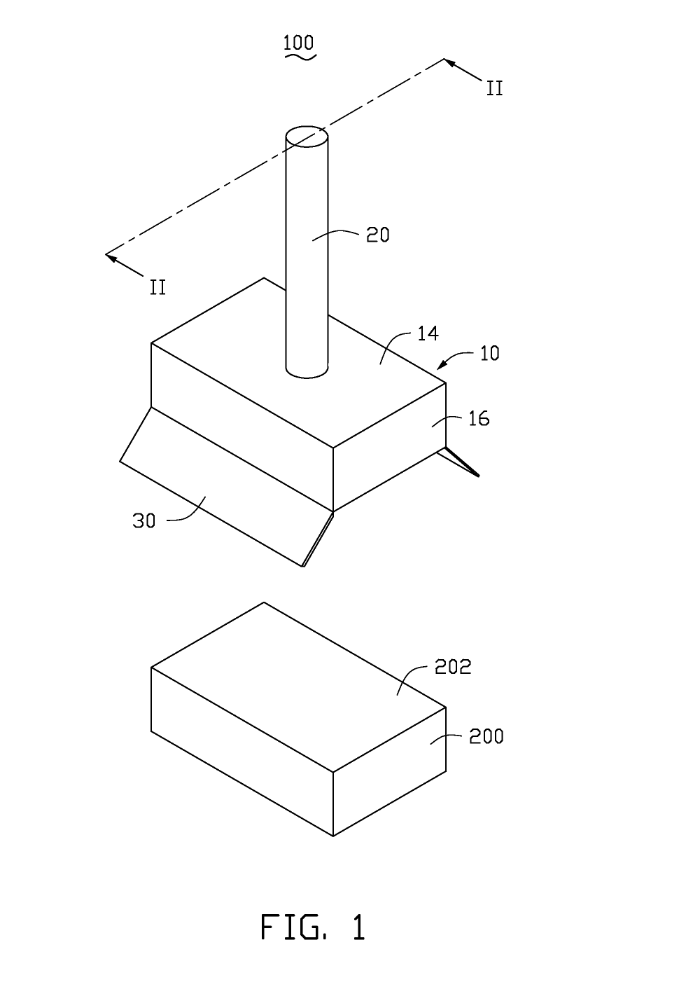

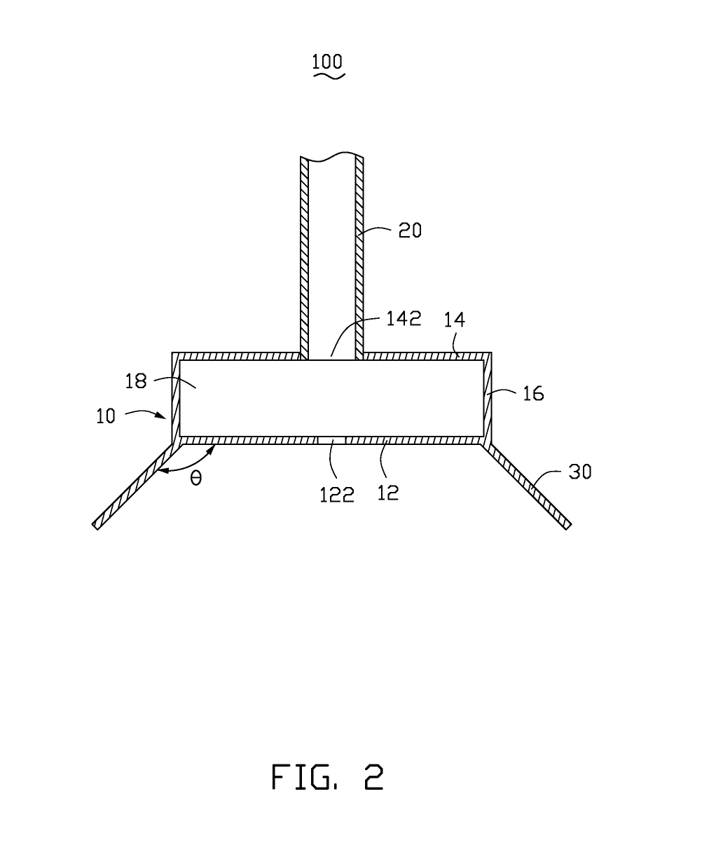

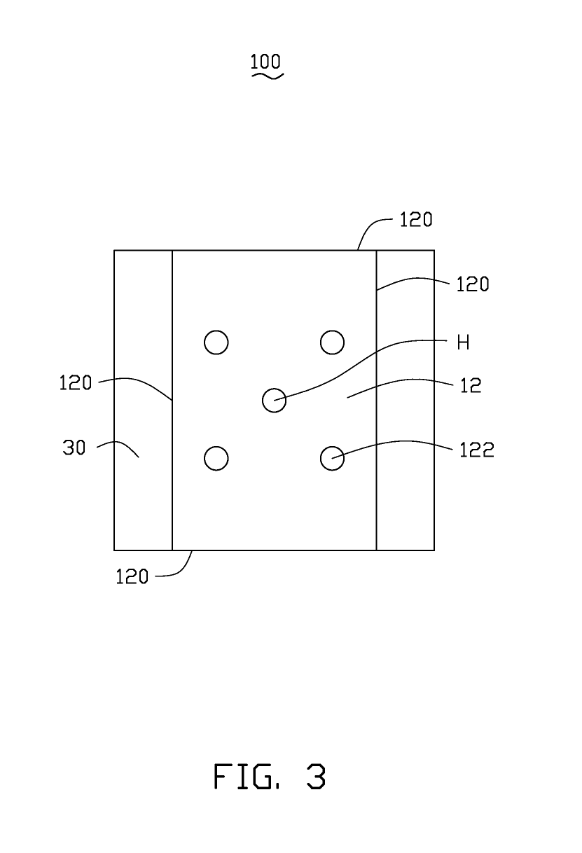

A first embodiment of a suction device 100 is shown in FIGS. 1, 2 and 3. The suction device 100 includes a sucking plate 10, a vacuum suction pipe 20, and two guide boards 30. The suction device is used to suck a workpiece 200. In one embodiment, the workpiece 200 is a light emitting coupling lens and includes a surface (sucking surface 202) that can be vacuum-lifted.

The sucking plate 10 is a rectangular cuboid and includes a bottom wall 12, a top wall 14, four side walls 16, and a ventilated cavity 18. The top wall 14 is opposite to the bottom wall 12 of the sucking plate. The top wall 14 and the bottom wall 12 are parallel to each other. Four side walls 16 are interconnected between the top wall 14 and the bottom wall 12, and are connected to each other end to end. The ventilated cavity 18 is surrounded by the bottom wall 12, the top wall 14, and the four side walls 16.

The bottom wall 12 is rectangular and includes four edges 120. A shape of the bottom wall 12 is equal to the sucking surface 202 and the bottom wall 12 is positioned to align with the sucking surface 202. A number of sucking holes 122 are positioned to the bottom wall 12 and are in communication with the ventilated cavity 18. The number of sucking holes 122 is uniformly distributed on the bottom wall 12 and can be used to achieve a mechanical equilibrium after the sucking plate 10 has sucked the workpiece 200. For example, the number of sucking holes 122 includes a first sucking hole 122 which is positioned to a center H of the bottom wall 12 and the first sucking hole 122 is surrounded by others. In one embodiment, five sucking holes 122 are uniformly distributed on the bottom wall 12, and one of five sucking holes 122 is positioned to a center H of the bottom wall 12 and is surrounded by four sucking holes 122. The layout of the sucking holes 122 is generally circular. In another embodiment, the sucking holes 122 can have a regular or an irregular shape, and include triangular, rectangular, and oval shapes.

The top wall 14 is rectangular. A connecting hole 142 is positioned to a center of the top wall 14. The connecting hole 142 is connected to the ventilated cavity 18.

The vacuum suction pipe 20 is connected to the connecting hole 142 of the top wall 14. The vacuum suction pipe 20 is configured to draw air from the ventilated cavity 18. When the sucking plate 10 is sucking the workpiece 200, the vacuum suction pipe 20 draws air from the ventilated cavity 18 and the number of sucking holes 122 is in communication with the ventilated cavity 18. Air pressure between the bottom wall 12 and the workpiece 200 is decreased and the sucking plate 10 can suck the workpiece 200 to the bottom wall 12.

Two guide boards 30 are positioned at two of the four edges 120 of the bottom wall 12, opposite to each other. The guide boards 30 are inclined to the bottom wall 12 in the direction away from the bottom wall 12 and the distance between the two guide boards 30 increases away from the top wall 14. In one embodiment, an angle θ between a guide board 30 and the bottom wall 12 is equal to 135°. In another embodiment, the angle θ between a guide board 30 and the bottom wall 12 is more than 90° and less than 180°. The angle θ comprises a range between 95° and 170° and the angle θ may be different between the two guide boards 30.

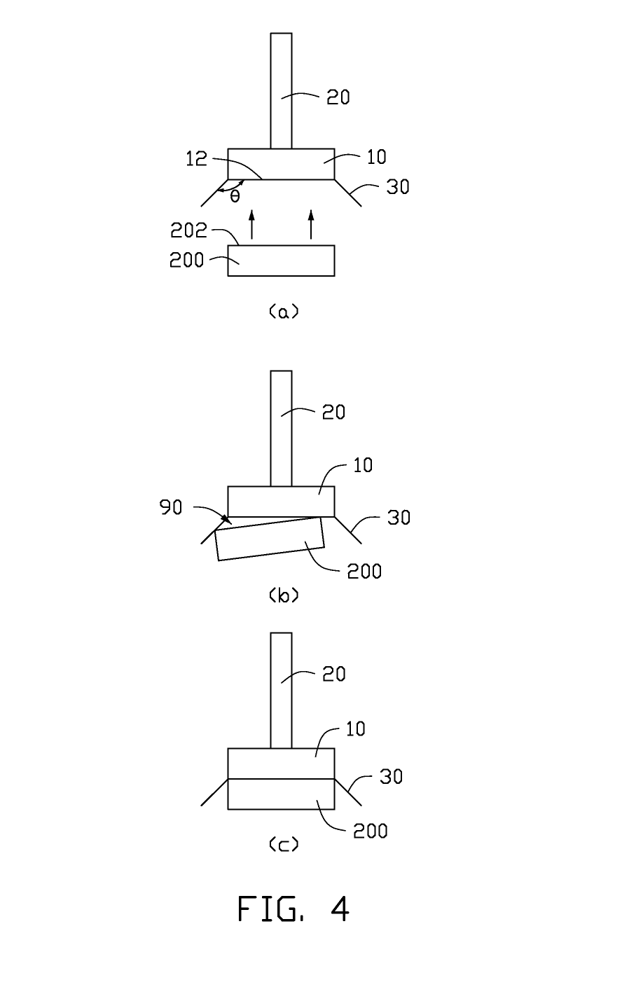

If the suction device 100 is substantially aligned with the sucking surface 202 at first, when the suction device 100 sucks the workpiece 200, the vacuum created can draw the sucking surface 202 to the bottom wall 12. If the suction device 100 is not aligned with the sucking surface 202 at first, in the example of FIG. 4, a space 90 exists between the sucking surface 202, the bottom wall 12, and the guide boards. The vacuum suction pipe 20 draws air continuously from the ventilated cavity 18 and the space 90, causing air pressure of the space 90 to decrease further. The sucking surface 202 is drawn closer and closer to the bottom wall 12 along the guide boards 30 until the workpiece 200 is adhered, correctly aligned, to the suction device 100.

A first embodiment of the suction device 100 provides a solution to increase the accuracy of the alignment between the workpiece 200 and the suction device 100 at directions of the surface normal vectors of the guide boards 30. More precisely, the suction device 100, comprising the vacuum suction pipe 20 of the suction device 100, draws air from the ventilated cavity 18, attracting the workpiece 200 to make contact with the bottom wall 12 and the guide boards 30. The shape of the bottom wall 12 being equal to that of the sucking surface 202, the increasing vacuum brings the sucking surface 202 into correct alignment with the bottom wall 12.

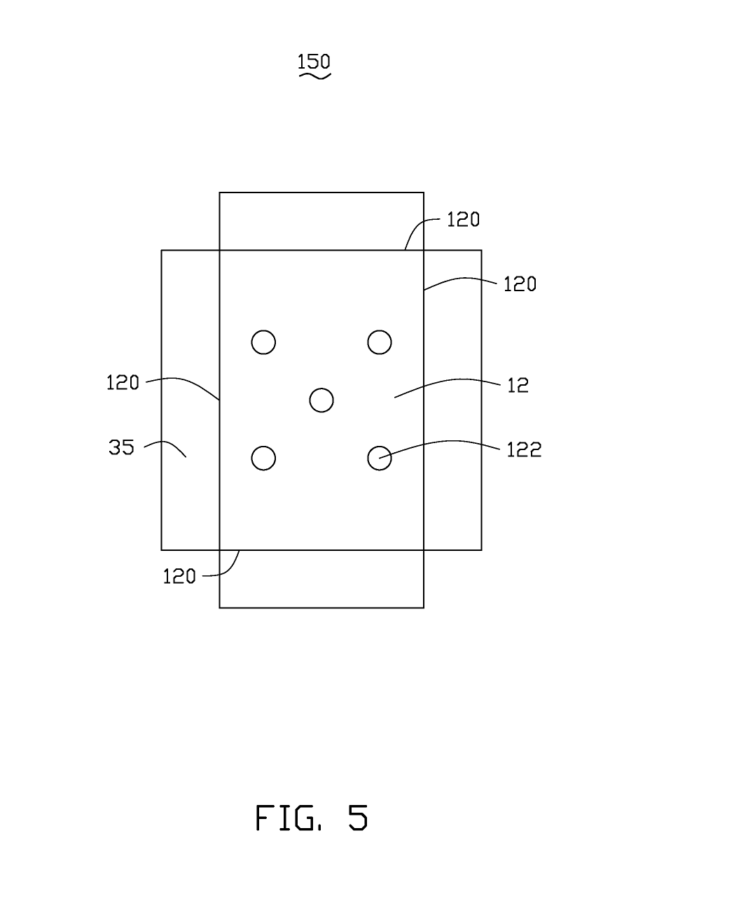

A second embodiment is shown in FIG. 5, to increase the accuracy of the alignment in two directions. Suction device 150 is similar to the suction device 100. Alternatively, the suction device 150 comprises four guide boards 35. Each one of the guide boards 35 is connected to one of the four edges 120 of the bottom wall 12.

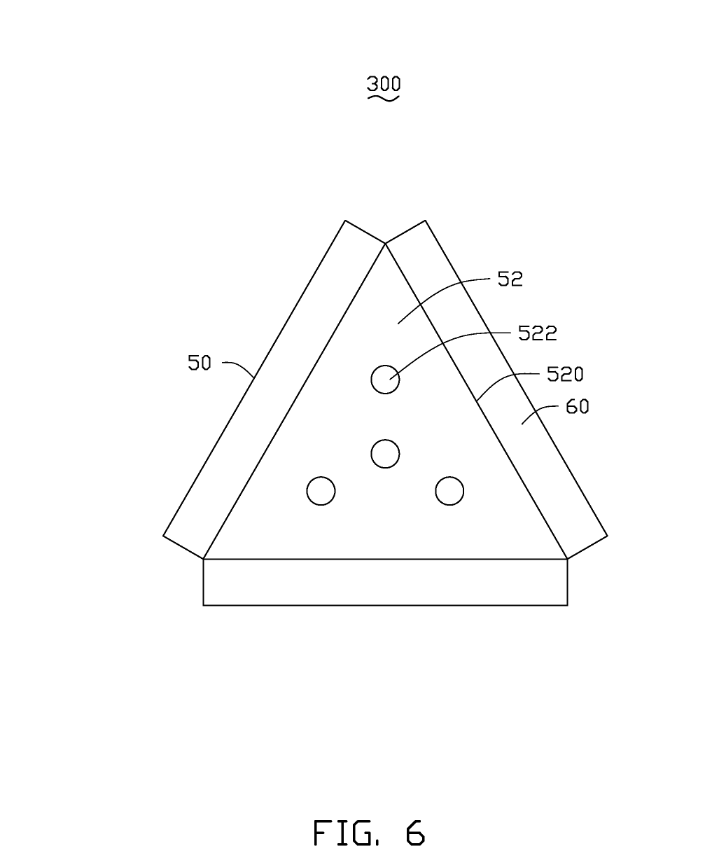

A third embodiment is shown in FIG. 6, and increases the accuracy of the sucking of a triangular sucking surface. Suction device 300 is similar to the suction device 100. Alternatively, the suction device 300 comprises a triangular prism of a sucking plate 50 and three guide boards 60. Each one of the guide boards 60 is connected to one of three edges 520 of a bottom wall 52. The bottom wall 52 includes four sucking holes 522 in uniform distribution on the bottom wall 52.

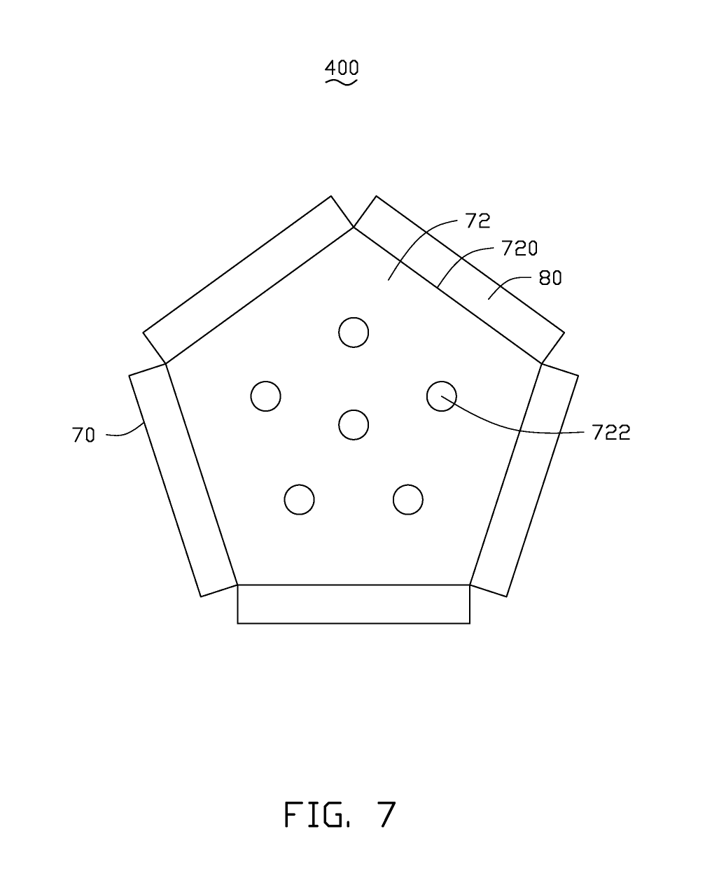

A fourth embodiment is shown in FIG. 7, and increases the accuracy of sucking a five-sided sucking surface. Suction device 400 is similar to the suction device 100. Alternatively, the suction device 400 comprises a pentagonal prism of a sucking plate 70 and five guide boards 80. Each one of the guide boards 80 is connected to one of five edges 720 of a bottom wall 72. The bottom wall 72 includes six sucking holes 722 in uniform distribution on the bottom wall 72.

The embodiments shown and described above are only examples. Many details are often found in the art such as the other features of a suction device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A suction device for sucking a workpiece, comprising:
a sucking plate comprising: a bottom wall including a plurality of sucking holes, a top wall opposite to the bottom wall, a plurality of side walls connected to each other and interconnected between the top wall and the bottom wall, a ventilated cavity surrounded by the bottom wall, the top wall and the side walls, a connecting hole configured to the top wall, wherein the connecting hole is in communication with the cavity and the sucking holes are in communication with the cavity,
a vacuum suction pipe connected to the connecting hole for drawing air from the cavity; and
a plurality of guide boards, wherein the guide boards are connected to at least one of edges of the bottom wall, and a distance between the guide boards increases away from the top wall.

2. The suction device in accordance with claim 1, wherein an angle between the bottom wall and the guide boards is a constant.

3. The suction device in accordance with claim 2, wherein an angle between the bottom wall and the guide boards is between 95° and 170°.

4. The suction device in accordance with claim 1, wherein the guide boards consist of two guide boards, the sucking plate is rectangular cuboid and the side walls of the sucking plate consist of four walls, wherein each one of the guide boards is connected to one of edges of the bottom wall and opposite to each other.

5. The suction device in accordance with claim 4, the sucking holes comprising a first sucking hole, wherein the first sucking hole is positioned to a center of the bottom wall and is surrounded by others of the sucking holes.

6. The suction device in accordance with claim 1, wherein the guide boards consist of four guide boards, the sucking plate is rectangular cuboid and the side walls of the sucking plate consist of four walls, wherein each one of the guide boards is connected to one of edges of the bottom wall.

7. The suction device in accordance with claim 6, the sucking holes comprising a first sucking hole, wherein the first sucking hole is positioned to a center of the bottom wall and is surrounded by others of the sucking holes.

8. The suction device in accordance with claim 1, wherein the bottom wall is a regular polygon and include the plurality of sucking holes distributed uniformly at the bottom wall, and the connecting hole is configured to a center of the top wall.

9. The suction device in accordance with claim 8, the sucking holes comprising a first sucking hole, wherein the first sucking hole is positioned to a center of the bottom wall and is surrounded by others of the sucking holes.

10. The suction device in accordance with claim 8, wherein the guide boards consist of three guide boards, the sucking plate is a triangular prism and the side walls of the sucking plate consist of three walls, wherein each one of the guide boards is connected to one of edges of the bottom wall.

11. The suction device in accordance with claim 8, wherein the guide boards consist of five guide boards, the sucking plate is a pentagonal prism and the side walls of the sucking plate consist of five walls, wherein each one of thethe guide boards is connected to one of edges of thethe bottom wall.

12. A suction device for sucking a workpiece, comprising:
a sucking plate including a bottom wall, a top wall opposite to the bottom wall, and side walls connected to each other and interconnected between the top wall and the bottom wall, the walls of the sucking plate defining a ventilated cavity surrounded by the walls of the sucking plate, the top wall defining a connecting hole for passage of air out of the cavity, and the bottom wall defining sucking holes for passage of air into the cavity,
a vacuum suction pipe connected to the top wall for drawing air from the cavity through the connecting hole and into the vacuum suction pipe, and
guide boards connected to edges of the bottom wall and inclined to the bottom wall in a direction away from the bottom wall, and a distance between the guide boards increases away from the top wall.
